(19) United States
(12) Patent Application Publication
(10) Pub. No.: US 2004/0176941 A1
(43) Pub. Date: Sep. 9, 2004

(54) Method of simulating computation instructions for an instruction set simulator

(76) Inventor: Shan-Chyun Ku, Hsinchu (TW)

Correspondence Address: RABIN & Berdo, PC, 1101 14TH STREET, NW, SUITE 500, WASHINGTON, DC, 20005, US

(21) Appl. No.: 10/377,615

(22) Filed: Mar. 4, 2003

(51) Int. Cl. G06F 9/45

(52) U.S. Cl. 703/22

(57) ABSTRACT

A method of simulating computation instructions for an instruction set simulator. First, a computation instruction is received by the instruction set simulator. Then, an operator and at least one operand of the computation instruction are stored to a data structure, and the computation instruction is simulated without computing flags. If a flag determination is received for simulation, the operator and the operand are read from the data structure. Then, a flag used in the flag determination is computed according to the operator and the operand, and the flag determination is simulated according to the flag.

### BACKGROUND OF THE INVENTION

1. Field of the Invention

The present invention relates to a simulation method of instruction set simulator (ISS), and particularly to a method of simulating computation instructions for an instruction set simulator, so as to speed the instruction set simulator.

2. Description of the Related Art

Instruction set simulators are major tools for the processor tool chain, such as CPU (Central Processing Unit) and DSP (Digital Signal Process) tool chains. The instruction set simulator can simulate processor behavior, instruction by instruction, and corresponding applications and software can thereby be verified more efficiently.

Since the instruction set simulator is an instruction-based simulator, it is much faster and easier to debug than cycle-accuracy simulators. In addition, since the instruction set simulator is software, it is widely available, cheaper than FPGA (Field Programmable Gate Array), and more convenient to evaluate.

The major contribution of processors is the ability to handle computation instructions. DSP applications have a large ratio of computation instructions, and DSP spends most of its time handling computation instructions. Each computation instruction usually accompanies the computations of status flags. Conventional instruction set simulators simulate each instruction according to its proper behavior, and data computation and flag computation are both simulated.

FIG. 1 shows the operation for each computation instruction of the conventional instruction set simulator. First, the computation instruction is simulated (step S11), and the flags AC (carry out), AV (overflow), AZ (zero), and AN (negative) are computed (step S12-S15). FIG. 2 shows the operation for each condition instruction with flag determination of the conventional instruction set simulator. First, the flag used in the condition instruction is read (step S21), and then the flag is verified (step S22). If the flag is true, the following instruction in the condition instruction is executed (step S23), and if the flag is not true, the flow finishes.

FIG. 3 shows an example of a computation instruction (31) and a condition instruction (32). For computation instruction (31) , conventional ISS first stores R0 by the result of R1 and R2, and then computes the status flags (AZ, AV, AC, and AN) of the operation. For condition instruction (32), the flag AV is checked for the operation's overflow status, and R0 is stored by ‘0×ffff° if the flag AV is true.

FIG. 4a is a table 41 illustrating the number of clock cycles for each computation instruction on X86 processors. As shown in FIG. 4a, each computation instruction takes 45 cycles on X86 processors, and the time (cycle) for flag computation is much longer than data computation. FIG. 4b is a table 42 illustrating the number of clock cycles for each condition instruction on X86 processors. As shown in FIG. 4b, the flag comparison takes 2 cycles and the following instruction in the condition instruction takes X cycle according to itself.

However, these flags are not frequently read for other determinations (an average of only one in three flags is read), therefore, the conventional instruction set simulator spends unnecessary time handling the flag computation.

### SUMMARY OF THE INVENTION

It is therefore an object of the present invention to provide a method of simulating computation instructions for an instruction set simulator, so as to speed up the instruction set simulator.

To achieve the above object, the present invention provides a method of simulating computation instructions for an instruction set simulator. According to an embodiment of the invention, a computation instruction is first received by the instruction set simulator. Then, an operator and at least one operand of the computation instruction are stored to a data structure, and the computation instruction is simulated without computing flags.

If a flag determination is received for simulation, the operator and the operand are read from the data structure. Then, a flag used in the flag determination is computed according to the operator and the operand, and the flag determination is simulated according to the flag.

According to the embodiment, the instruction set simulator may be a CPU instruction set simulator or a DSP instruction set simulator.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flowchart illustrating the operation for each computation instruction of a conventional instruction set simulator;

FIG. 2 is a flowchart illustrating the operation for each condition instruction with flag determination of conventional instruction set simulator;

FIG. 3 shows an example of a computation instruction and a condition instruction;

FIG. 4a shows the number of clock cycles for each computation instruction on X86 processors;

FIG. 4b shows the number of clock cycles for each condition instruction on X86 processors;

FIG. 5a and 5b are flowcharts illustrating the operation of the method of simulating computation instructions for an instruction set simulator according to the present invention;

FIG. 6a shows the number of clock cycles for each computation instruction on X86 processors according to the present invention;

FIG. 6b shows the number of clock cycles for each condition instruction on X86 processors according to the present invention;

FIG. 7a and 7b respectively show profiles from an MP-3 player for conventional ISS and the inventive ISS; and

FIG. 8 illustrates the comparison of conventional ISS and the inventive ISS in handling computation and condition instructions for an MP-3 player.

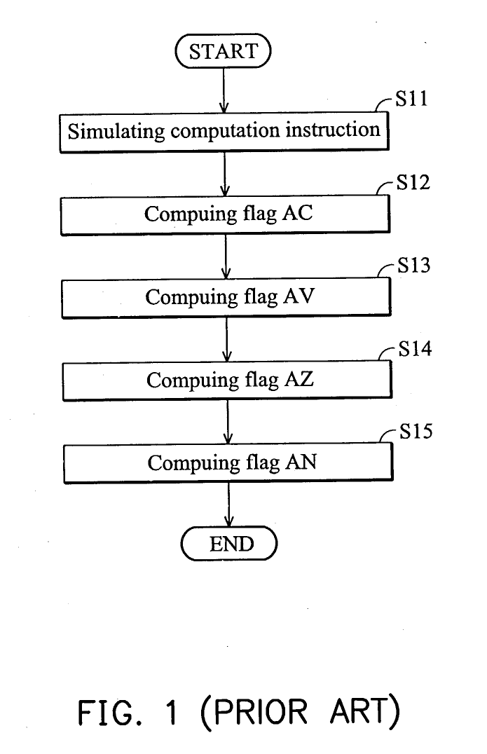

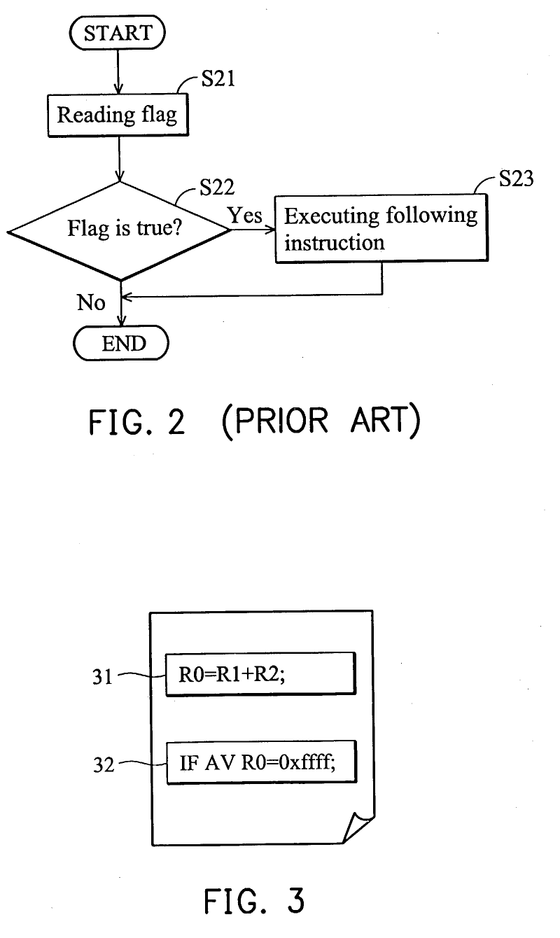

### DETAILED DESCRIPTION OF THE INVENTION

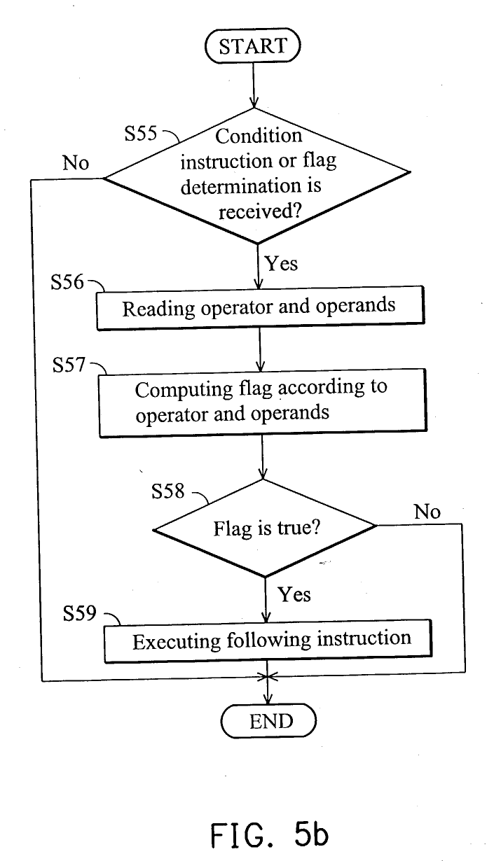

FIGS. 5a and 5b illustrate the operation of the method of simulating computation instructions for an instruction set simulator according to the present invention.

First, referring to FIG. 5a, in step S51, a computation instruction is received for simulation by the instruction set simulator. Then, in step S52, at least one operator of the computation instruction is stored to a data structure, such as a buffer, register or a memory space. Then, in step S53, at least one operand of the computation instruction is stored to the data structure.

Thereafter, in step S54, the computation instruction is simulated by the instruction set simulator without computing flags. It should be noted that the instruction set simulator may comprise CPU instruction set simulators, DSP instruction set simulators, or instruction set simulators of computation-intensive processors.

Referring to FIG. 5b, if a condition instruction or a flag determination is received by the instruction set simulator (yes in step S55), in step S56, the operator and the operand are read from the data structure, and in step S57, the flag used in the condition instruction or the flag determination is computed according to the operator and the operand.

Afterward, in step S58, the flag is verified. If the flag is true (yes in step S58), in step S59, the following instruction in the condition instruction or designated by the flag determination is executed, and if the flag is not true (no in step S58), the flow finishes.

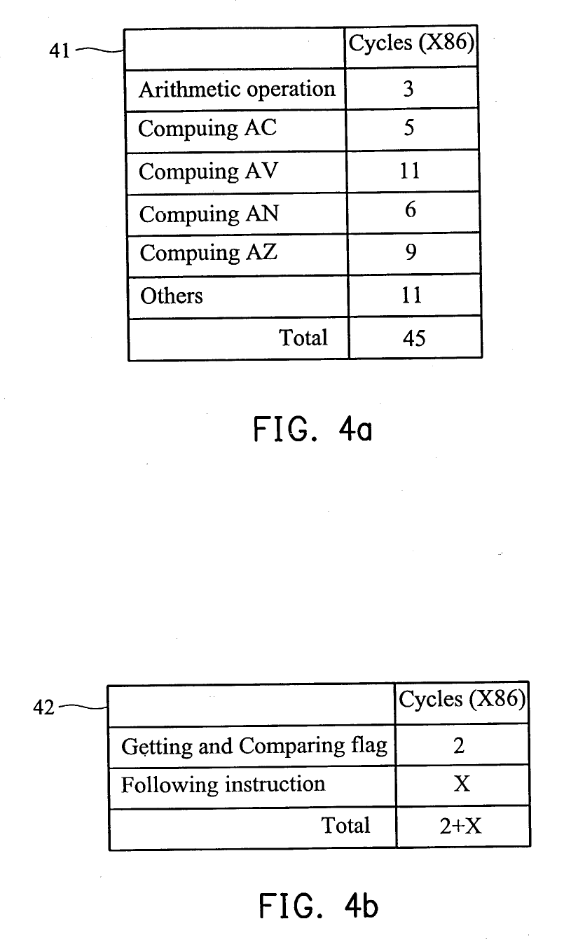

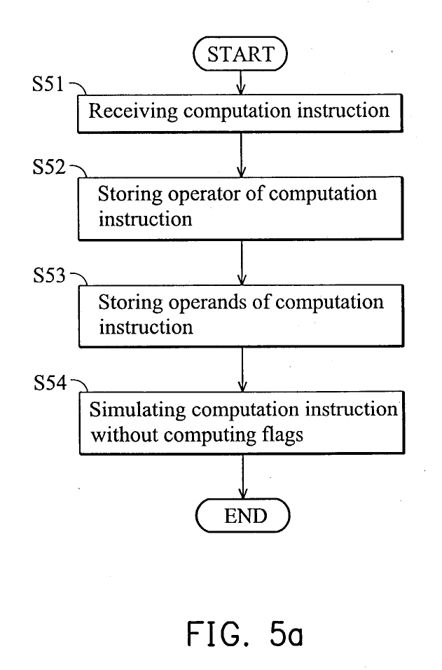

Referring to FIG. 3 again, the ISS according to the present invention stores ‘+’, R1, and R2 into the buffer, and computes R0 as R1+R2 for computation instruction (31). For condition instruction (32), the operator and operands are read from the buffer and the flag AV is computed according to ‘+’, R1, and R2. Then, the flag AV is checked for the operation's overflow status, and R0 is stored by ‘0×’ if the flag AV is true.

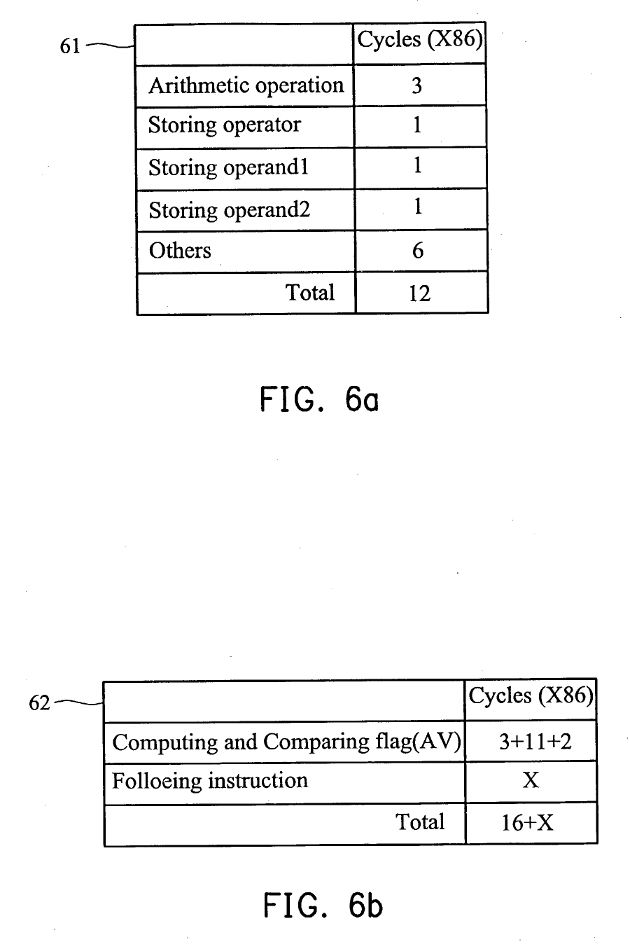

FIG. 6a is a table 61 illustrating the number of clock cycles for each computation instruction on X86 processors according to the present invention. As shown in FIG. 6a, each computation instruction takes 12 cycles on X86 processors. FIG. 6b is a table 62 illustrating the number of clock cycles for each condition instruction on X86 processors according to the present invention. As shown in FIG. 6b, the flag comparison takes 16 cycles including read operator and operators for 3 cycles, computing the flag AV for 11 cycles, and comparing flag for 2 cycles, and the following instruction in the condition instruction takes X cycle according to itself.

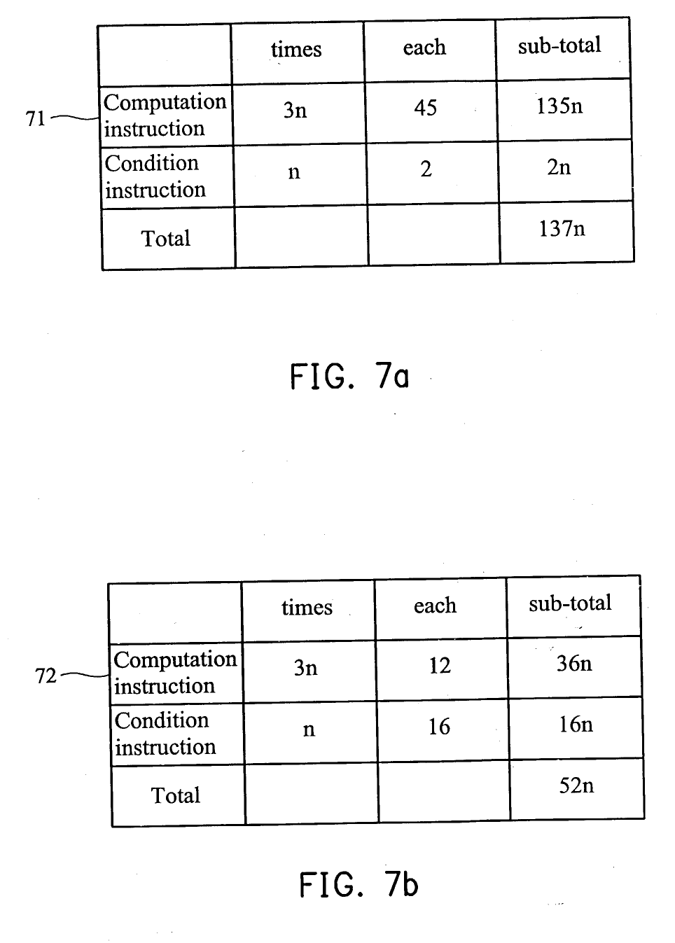

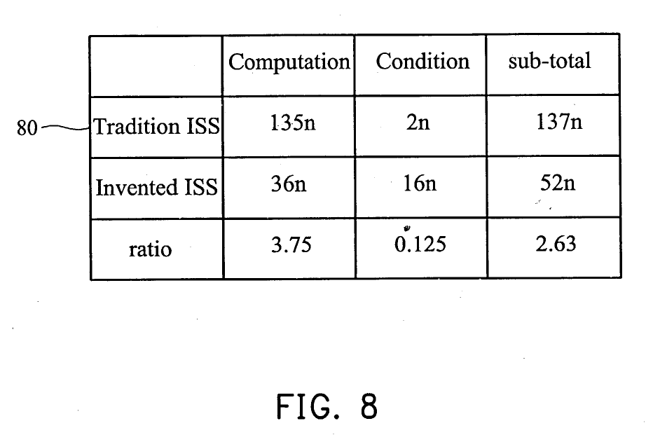

FIG. 7a and 7b respectively show profiles from an MP-3 player for conventional ISS and the inventive ISS. Since the MP-3 player is a computation-intensive application, its computation instructions total 3 times the normal number of condition instructions. Therefore, the total cycles for conventional ISS and the inventive ISS are 137n and 52n respectively, and the performance improvement is dramatic as illustrated in FIG. 8.

As a result, using the method of simulating computation instructions for an instruction set simulator, the performance of instruction set simulators can be improved.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method of simulating computation instructions for an instruction set simulator, comprising the steps of:
receiving a computation instruction;
storing an operator of the computation instruction to a buffer;
storing a first operand of the computation instruction to the buffer;
storing a second operand of the computation instruction to the buffer;
simulating the computation instruction without computing flags;
reading the operator, the first operand, and the second operand from the buffer if a condition instruction is received by the instruction set simulator;
computing at least one flag used in the condition instruction according to the operator, the first operand, and the second operand; and
simulating the condition instruction according to the flag.

2. The method as claimed in claim 1 wherein the method for simulating the computation instruction, comprising the steps of:
determining whether the flag is true; and
executing an instruction of the condition instruction if the flag is true.

3. The method as claimed in claim 1 wherein the flag is overflow flag (AV).

4. The method as claimed in claim 1 wherein the instruction set simulator is a DSP instruction set simulator.

5. The method as claimed in claim 1 wherein the instruction set simulator is a CPU instruction set simulator.

6. A method of simulating computation instructions for an instruction set simulator, comprising the steps of:
receiving a computation instruction;
storing an operator of the computation instruction to a buffer;
storing a first operand of the computation instruction to the buffer;
storing a second operand of the computation instruction to the buffer; and
simulating the computation instruction without computing flags.

7. The method as claimed in claim 6 further comprising the steps of:
reading the operator, the first operand, and the second operand from the buffer if a condition instruction is received by the instruction set simulator;
computing at least one flag used in the condition instruction according to the operator, the first operand, and the second operand; and
simulating the condition instruction according to the flag.

8. The method as claimed in claim 7 wherein the method for simulating the computation instruction further comprises the steps of:
determining whether the flag is true; and
executing an instruction of the condition instruction if the flag is true.

9. The method as claimed in claim 7 wherein the flag is overflow flag (AV).

10. The method as claimed in claim 6 wherein the instruction set simulator is a DSP instruction set simulator.

11. The method as claimed in claim 6 wherein the instruction set simulator is a CPU instruction set simulator.

12. A method of simulating computation instructions for an instruction set simulator, comprising the steps of:
receiving a computation instruction;
storing at least one operator and at least one operand of the computation instruction to a data structure;
simulating the computation instruction without computing flags;
reading the operator and the operand from the data structure if a flag determination is received for simulation by the instruction set simulator;
computing a flag used in the flag determination according to the operator and the operand; and
simulating the flag determination according to the flag.

13. The method as claimed in claim 12 wherein the instruction set simulator is a DSP instruction set simulator.

14. The method as claimed in claim 12 wherein the instruction set simulator is a CPU instruction set simulator.
